(19) United States
(12) Patent Application Publication
(10) Pub. No.: US 2004/0165642 A1
(43) Pub. Date: Aug. 26, 2004

(54) Laser mirror housing

(76) Inventor: Shaun Lamont, Galveston, TX (US)

Correspondence Address: SLATER & MATSIL, L.L.P., 17950 PRESTON RD, SUITE 1000, DALLAS, TX, 75252-5793, US

(21) Appl. No.: 10/794,823

(22) Filed: Mar. 5, 2004

Related U.S. Application Data
(60) Provisional application No. 60/466,912, filed on Apr. 30, 2003.

(51) Int. Cl. H01S 3/08

(52) U.S. Cl. 372/107; 359/543

(57) ABSTRACT

A mirror housing and a method of housing a mirror for a laser measurement system. The laser mirror housing is T-shaped, with both portions of the T being cylindrical. A mirror is mounted within the mirror housing at a 45 degree angle. A first transparent cover is disposed over a first opening over the mirror. A second transparent cover may be disposed over a second opening opposite the first opening, and the second transparent cover may be used for a spare, in the event that the first transparent cover is damaged.

This application claims the benefit of U.S. Provisional Application No. 60/466,912, filed on Apr. 30, 2003, entitled “Laser Mirror Housing,” which application is hereby incorporated herein by reference.

### TECHNICAL FIELD

The present invention relates generally to mirrors used in laser measurement systems, and more particularly to a mirror housing and a method of housing a mirror for a laser measurement system.

### BACKGROUND

Laser technology has been used in recent years in many applications, including scanning and dimensioning applications. Surveyors use laser scanners to survey land, for example. Other applications for laser scanners include engineering and construction applications, as examples. A laser beam is transmitted and reflects back to the laser scanner or laser measurement system, and the laser scanner or laser measuring system analyzes the reflected beam and determines distance and measurement information.

One such laser scanner is the AccuRange™ Line Scanner manufactured by Acuity Research in Menlo Park, Calif. The line scanner includes a scanning mirror that sweeps a laser beam through 360 degrees and returns reflected light or laser beams to a laser measurement system or rangefinder. The line scanner is adapted to scan thousands of lines per minute.

A problem with prior art line scanners is that the mirror that reflects the laser beam is fragile and may break easily. Furthermore, the mirror is exposed, allowing dust, dirt, fluids and contaminants to make contact with the mirror, requiring that the mirror be cleaned frequently, or possibly causing damage to the mirror, requiring its replacement.

### SUMMARY OF THE INVENTION

These and other problems are generally solved or circumvented, and technical advantages are generally achieved, by preferred embodiments of the present invention, in which a laser mirror housing provides mechanical support and protection for a scanning mirror of a laser measurement system. The housing includes a transparent cover disposed over the mirror that prevents debris, water or contaminants from reaching and lodging on the mirror. In one embodiment, the housing includes a spare transparent cover opposite the transparent cover over the mirror, providing a spare cover in the event that the transparent cover for the mirror is damaged, and also providing dynamic balancing of the laser housing.

In accordance with a preferred embodiment of the present invention, a housing for a mirrored reflector of a laser system includes a first cylindrical portion positioned along a first axis, the first cylindrical portion having a first end and a second end, and a second cylindrical portion positioned along a second axis having a first end and a second end, the second end of the second cylindrical portion being coupled to an opening in the side of the first cylindrical portion. The second axis is positioned at a substantially 90 degree angle from the first axis. The first end of the second cylindrical portion comprises a first opening of the housing. The first end of the first cylindrical portion comprises a second opening of the housing. The second end of the first cylindrical portion comprises a third opening of the housing. A mirrored reflector is disposed within and is attached to the first cylindrical portion, the mirrored reflector being positioned at a substantially 45 degree angle with respect to the first axis and the second axis, the mirrored reflector comprising a reflective surface, wherein the reflective surface faces the first opening and the second opening of the housing.

In accordance with another preferred embodiment of the present invention, a method of housing a mirrored reflector of a laser system includes providing a housing, the housing including a first cylindrical portion positioned along a first axis, the first cylindrical portion having a first end and a second end, and a second cylindrical portion positioned along a second axis having a first end and a second end, the second end of the second cylindrical portion being coupled to an opening in the side of the first cylindrical portion, the second axis being positioned at a substantially 90 degree angle from the first axis, wherein the first end of the second cylindrical portion comprises a first opening of the housing, and wherein the first end of the first cylindrical portion comprises a second opening of the housing. The method includes attaching the mirrored reflector having a reflective surface within the first cylindrical portion of the housing at a substantially 45 degree angle with respect to the first axis and the second axis, so that the reflective surface faces the first opening and the second opening of the housing.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention, and the advantages thereof, reference is now made to the following descriptions taken in conjunction with the accompanying drawings, in which:

FIG. 1 is a cross-sectional view of a laser mirror housing in accordance with an embodiment of the present invention;

FIG. 2 is a front view of the laser mirror housing shown in FIG. 1;

FIG. 3 is a perspective view of the laser mirror housing shown in FIGS. 1 and 2; and

FIG. 4 shows a perspective view of the laser mirror housing shown in FIGS. 1 through 3 in use in a laser measurement system.

Corresponding numerals and symbols in the different figures generally refer to corresponding parts unless otherwise indicated. The figures are drawn to clearly illustrate the relevant aspects of the preferred embodiments and are not necessarily drawn to scale.

### DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a laser mirror housing for a laser measurement system or line scanner. The invention may also be applied, however, to other laser applications where a laser beam is reflected using a mirror.

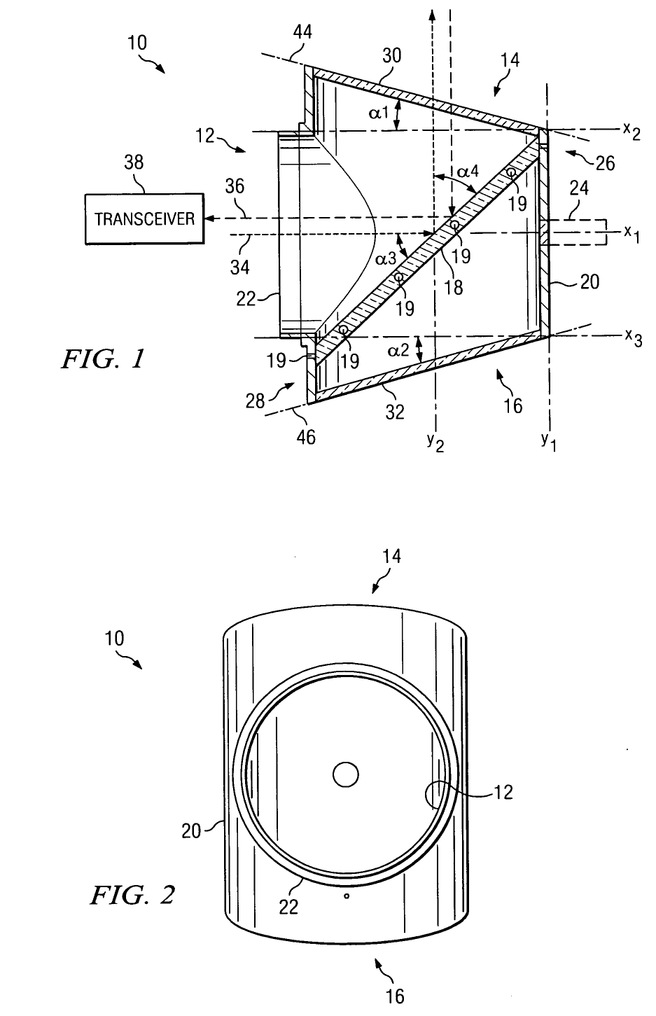

With reference now to FIG. 1, there is shown a laser mirror housing 10 in accordance with an embodiment of the present invention for use with a laser measuring system 42 (not shown in FIG. 1; see FIG. 4) for capturing laser dimensional data. The laser mirror housing 10 is adapted to support a mirrored reflector 18 disposed inside the protective housing 10. The mirror 18 is adapted to deflect a laser beam 34 and 36 received and sent from a transceiver 38 of a laser measuring system 42. The transceiver 38 may include a laser transmitter and receiver, as examples.

A cross-sectional view of the housing 10 is shown in FIG. 1. The mirror housing 10 is preferably T-shaped and is preferably comprised of aluminum, as an example. Alternatively, the mirror housing 10 may comprise composite plastics or other metals such as stainless steel, as an example, and may comprise other shapes, for examples. The mirror housing 10 preferably comprises a first cylindrical portion 20 and a second cylindrical portion 22, as shown. The first cylindrical portion 20 and second cylindrical portion 22 preferably are positioned with respect to one another in a T-shape, for example, at a substantially 90 degree angle. The mirror housing 10 first cylindrical portion 20 and second cylindrical portion 22 may be manufactured in two discrete components and then attached together, e.g., by welding, or alternatively, the first and second cylindrical portions 20 and 22 may be manufactured as a single piece.

The housing 10 preferably comprises a first opening 12 at a first end of the second cylindrical portion 22. The second end of the second cylindrical portion 22 is attached to and abuts a side (e.g., an aperture or opening in the side) of the first cylindrical portion 20. The housing 10 includes a second opening 14 at a first end of the first cylindrical portion 20, and a third opening 16 at a second end of the second cylindrical portion 20. The first, second and third openings 12, 14, and 16 are preferably round or oval, as examples, although the first, second and third openings 12, 14, and 16 may alternatively comprise other shapes.

The mirror housing 10 is adapted to retain and support a mirrored reflector 18, also referred to herein as a mirror 18, that may be mounted therein. The mirrored reflector 18 preferably comprises a mirror 18. The mirrored reflector 18 may comprise glass with a reflective material disposed on the back thereof, and may alternatively comprise gold, silicon or other metals having a high reflectivity, as examples. The mirror 18 preferably may be adhered to the interior of the first cylindrical portion 20 of the mirror housing 10 by a mirror attachment means 19, comprising rivets or glue, as examples, although other attachment means 19 may be used to attach the mirror 18 to the housing 10. The mirror 18 may be round or oval, as examples, although the mirror 18 may alternatively comprise other shapes.

The mirror 18 is preferably attached to the first cylindrical portion 20 of the mirror housing 10 extending between a top region 26 of the first cylindrical portion 20 and a bottom region 28 of the first cylindrical portion 20, for example. Preferably, the diameter of the first opening 12 is not greater than the distance between the first cylindrical portion 20 top region 26 and bottom region 28, for example.

The mirror 18 is adapted to reflect an input laser beam 34 received through the first opening 12 from a laser transceiver 38 along axis x1 outwardly away from the housing 10 through the second opening 14 along axis y2. The laser beam transmitted 34 is returned to the mirror 18, shown in FIG. 1 as laser beam received 36, through the second opening 14. The mirror reflector 18 is adapted to reflect the laser beam received 36 through the first opening 12 to the transceiver 38. The laser beam 36 received by the laser transceiver 38 is analyzed by a processor (not shown) and converted into dimensional information.

The mirror housing 10 preferably includes a first transparent cover 30 disposed over the second opening 14. The first transparent cover 30 preferably comprises a transparent material, such as glass or plastic, as examples, although the first transparent cover 30 may alternatively comprise other materials. The mirror is positioned within the housing 10 and the transparent cover 30 is located at an exterior edge, e.g., along plane 44, of the housing 10.

Optionally, the mirror housing 10 may also include a second transparent cover 32 disposed over the third opening 16. The second transparent cover 32 functions to evenly balance the housing 10 and also functions as a spare transparent cover to replace the first transparent cover 30. The second transparent cover 32 preferably comprises the same material as the first transparent cover 30, for example.

The plane 44 of the first end of the mirror housing first cylindrical portion 20, e.g., proximate the second opening 14, is preferably positioned at an angle α1 with respect to a line x2 that is parallel to the rotational axis x1 and line y1 that runs along a side of the housing first cylindrical portion 20, for example. Similarly, the plane 46 of the second end of the mirror housing first cylindrical portion 20, e.g., proximate the third opening 14, is preferably positioned at an angle α2 with respect to a line x3 that is parallel to the rotational axis x1, and line y1, for example. Angle α1 and angle α2 may comprise 45 degrees or less, for example. Preferably, the first cylindrical portion 20 of the mirror housing is symmetric about the rotational axis x1; therefore, the angles α1 and angle α2 are preferably substantially equal.

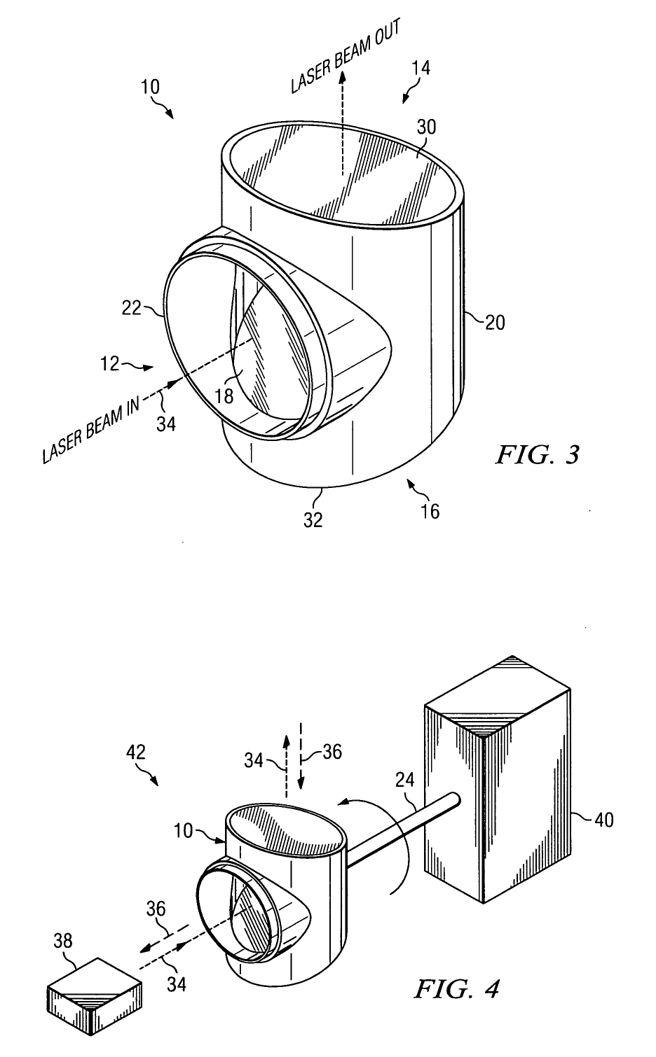

A front view of an embodiment of the present mirror housing 10 is shown in FIG. 2. The housing 10 is shown without a mirror 18 installed therein. A perspective view of an embodiment of the mirror housing 10 is shown in FIG. 3.

Referring again to FIG. 1, the mirror 18 is preferably disposed or positioned within the mirror housing 10 at an angle α3 between the rotational axis x1 and mirror 18. Similarly, the mirror 18 is preferably disposed or positioned within the mirror housing 10 at an angle α4 between line y2 and the mirror 18. Angles α3 and α4 are preferably about 45 degree angles, for example. An outgoing laser beam 34 sent from a laser transceiver 38 is reflected off of the front of the mirror 18, through the mirror housing 10 and outwards through the second opening 14. The laser beam 34 is refracted or reflected from an object external to the mirror housing 10, and returns laser light 36 back through opening 14 onto the front surface of the mirror 18, through the mirror housing 10, and back to the laser transceiver 38. The housing 10 is rotatable about a shaft 24 that is positioned concentrically with the rotational axis x1.

FIG. 4 shows the mirror housing 10 in accordance with an embodiment of the present invention used in a laser measuring system 42. The laser mirror housing 10 may include a shaft 24 coupled along axis x1 (see FIG. 1) to a side of the first cylindrical portion 20 opposite the first opening 12 in the second cylindrical portion 22. The shaft 24 may be coupled to a motor 40 that is adapted to rotate the mirror housing 10 about the receiving axis x1. The mirror housing 10 may then be rotated 360 degrees in order to obtain dimensional and distance measurements.

The novel laser mirror housing 10 described herein may be used to replace the reflection and mirror system of a line scanner or laser measurement system such as the AccuRange™ Line Scanner manufactured by Acuity Research and may be used in other line scanners and laser measurement systems, as examples.

The mirror housing 10 described herein provides several technical advantages and beneficial features for a laser measurement system. First, the housing 10 provides a means of mounting the mirror 18 to be supported. Second, the housing 10 is designed to provide a mounting to allow for fine adjustment of the mirror 18 to any orientation required, during the manufacturing of the mirror housing assembly 10, for example. Third, the housing provides protection for the mirror 18 shape. The housing 10 functions as a structural cage to protect the mirror 18.

In addition, the housing 10 includes a transparent cover 30 that provides protection for the mirror 18 surface, and also functions as an ingress protector, e.g., for the ingress of contaminants such as water and/or dust, as examples. The housing 10 is preferably dynamically balanced by being symmetrical in nature. For example, the housing preferably has a portion 20 that is substantially cylindrical in shape, with each end of the housing being angled at a predetermined degree, e.g., at angles α1 and angle α2.

The optional second transparent cover 32 may be used as a spare to replace the first transparent cover 30, in the event that the first transparent cover 30 is broken, damaged or lost, for example.

Embodiments of the invention include a method of laser measuring utilizing the mirror housing described herein, a method of housing a mirror with the housing described herein, and a system for laser measurement that utilizes the mirror housing described herein.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A housing for a mirrored reflector of a laser system, the housing comprising:
a first cylindrical portion positioned along a first axis, the first cylindrical portion having a first end and a second end;
a second cylindrical portion positioned along a second axis having a first end and a second end, the second end of the second cylindrical portion being coupled to an opening in the side of the first cylindrical portion, the second axis being positioned at a substantially 90 degree angle from the first axis, wherein the first end of the second cylindrical portion comprises a first opening of the housing, wherein the first end of the first cylindrical portion comprises a second opening of the housing, and wherein the second end of the first cylindrical portion comprises a third opening of the housing; and
a mirrored reflector disposed within and attached to the first cylindrical portion, the mirrored reflector being positioned at a substantially 45 degree angle with respect to the first axis and the second axis, the mirrored reflector comprising a reflective surface, wherein the reflective surface faces the first opening and the second opening of the housing.

2. The housing according to claim 1, further comprising a first transparent cover disposed over the second opening of the housing.

3. The housing according to claim 2, wherein the first transparent cover is positioned at an angle of about 45 degrees or less from a side of the housing opposite the first opening of the housing.

4. The housing according to claim 2, wherein the first transparent cover comprises glass or plastic.

5. The housing according to claim 2, further comprising a second transparent cover disposed over the third opening of the housing.

6. The housing according to claim 5, wherein the second transparent cover is positioned at an angle of about 45 degrees or less from a side of the housing opposite the first opening of the housing, and wherein the second transparent cover is positioned symmetrically within the housing relative to the first transparent cover.

7. The housing according to claim 5, wherein the second transparent cover comprises the same material as the first transparent cover.

8. The housing according to claim 5, wherein the second transparent cover and the first transparent cover are removeably attached to the first cylindrical portion of the housing.

9. The housing according to claim 8, wherein the second transparent cover comprises a spare cover for the first transparent cover.

10. The housing according to claim 1, wherein the first cylindrical portion is symmetric about the second axis.

11. The housing according to claim 1, further comprising a shaft attached to the side of the first cylindrical portion opposite the first opening in the housing, the shaft being positioned along the second axis, wherein the housing is rotatable by the shaft about the second axis.

12. The housing according to claim 1, wherein the first cylindrical portion and the second cylindrical portion comprise metal or plastic.

13. The housing according to claim 1, wherein the first cylindrical portion and the second cylindrical portion comprise a single integral component.

14. The housing according to claim 1, wherein the first cylindrical portion and the second cylindrical portion comprise separate, discrete components, wherein the second cylindrical portion is attached to the first cylindrical portion, or wherein the first cylindrical portion is attached to the second cylindrical portion.

15. A laser system comprising the housing for a mirrored reflector according to claim 1.

16. A method of housing a mirrored reflector of a laser system, the method comprising:
providing a housing, the housing comprising:
a first cylindrical portion positioned along a first axis, the first cylindrical portion having a first end and a second end;
a second cylindrical portion positioned along a second axis having a first end and a second end, the second end of the second cylindrical portion being coupled to an opening in the side of the first cylindrical portion, the second axis being positioned at a substantially 90 degree angle from the first axis, wherein the first end of the second cylindrical portion comprises a first opening of the housing, and wherein the first end of the first cylindrical portion comprises a second opening of the housing; and
attaching the mirrored reflector having a reflective surface within the first cylindrical portion of the housing at a substantially 45 degree angle with respect to the first axis and the second axis, so that the reflective surface faces the first opening and the second opening of the housing.

17. The method according to claim 16, further comprising attaching a first transparent cover over the second opening of the housing.

18. The method according to claim 17, wherein attaching the first transparent cover comprises attaching the first transparent cover at an angle of about 45 degrees or less from a side of the housing opposite the first opening of the housing.

19. The method according to claim 18, wherein attaching the first transparent cover comprises attaching a glass or plastic cover.

20. The method according to claim 16, wherein the housing comprises a third opening at the second end of the first cylindrical portion, further comprising attaching a second transparent cover disposed over the third opening of the housing.

21. The method according to claim 20, wherein attaching the second transparent cover comprises attaching the second transparent cover at an angle of about 45 degrees or less from a side of the housing opposite the first opening of the housing, so that the second transparent cover is positioned symmetrically within the housing relative to the first transparent cover.

22. The method according to claim 20, wherein attaching the second transparent cover comprises attaching a cover comprising the same material as the first transparent cover.

23. The method according to claim 20, wherein attaching the second transparent cover and attaching the first transparent cover comprise removeably attaching the second transparent cover and the first transparent cover to the first cylindrical portion of the housing.

24. The method according to claim 23, wherein the second transparent cover comprises a spare cover for the first transparent cover.

25. The method according to claim 16, wherein providing the housing comprises providing a housing wherein the first cylindrical portion of the housing is symmetric about the second axis.

26. The method according to claim 16, further comprising attaching a shaft to the side of the first cylindrical portion opposite the first opening in the housing, the shaft being positioned along the second axis, wherein the housing is rotatable by the shaft about the second axis.

27. The method according to claim 16, wherein providing the housing comprises providing a housing wherein the first cylindrical portion and the second cylindrical portion comprise metal or plastic.

28. The method according to claim 16, wherein providing the housing comprises providing a housing wherein the first cylindrical portion and the second cylindrical portion comprise a single integral component.

29. The method according to claim 16, wherein providing the housing comprises providing a housing wherein the first cylindrical portion and the second cylindrical portion comprise separate, discrete components, wherein the second cylindrical portion is attached to the first cylindrical portion, or wherein the first cylindrical portion is attached to the second cylindrical portion.

30. A method of laser measurement comprising:
passing a laser beam into the first opening of the housing according to claim 1;
receiving a reflected laser beam from the first opening of the housing; and
analyzing the reflected laser beam to determine distance information.

31. The method according to claim 30, wherein the laser beam passed into the first opening of the housing is reflected by the mirrored reflector and passes out of the housing through the second opening, and wherein the reflected laser beam reenters the housing through the second opening, is reflected by the mirrored reflector, and passes out of the housing through the first opening.
